(19) United States
(12) Patent Application Publication
(10) Pub. No.: US 2023/0084522 A1
(43) Pub. Date: Mar. 16, 2023

(54) CONNECTOR

(71) Applicant: YAZAKI CORPORATION, Tokyo (JP)

(72) Inventors: Shunsuke NARAMA, Shizuoka (JP); Shoji Yamamoto, Shizuoka (JP)

(73) Assignee: YAZAKI CORPORATION, Tokyo (JP)

(21) Appl. No.: 17/942,647

(22) Filed: Sep. 12, 2022

(30) Foreign Application Priority Data
Sep. 13, 2021 (JP) 2021-148321

(51) Int. Cl. H01R 13/641; H01R 13/627

(52) U.S. Cl. CPC H01R 13/641; H01R 13/6272

(57) ABSTRACT

A connector includes a first housing, a second housing configured to be fitted to the first housing; a rotation member rotatably supported on the first housing; a lock arm including a lock part configured to lock with a lockable part of the first housing in a fitting completion position, an operation section configured to release the lock arm from a locked state, and a fulcrum part connected to an outer peripheral surface of the rotation member at a position between the lock part and the operation section, and configured to swing around the fulcrum part and to lock or release the lock arm by elastic deformation thereof; and a fitting detection member configured to detect a fitted state of the first housing and the second housing while being assembled to the rotation member and when moving in a locking direction from a temporally lock position to a fitting confirmation position.

### CROSS REFERENCE TO RELATED APPLICATION

The present application is based on, and claims priority from the prior Japanese Patent Application No. 2021-148321, filed on Sep. 13, 2021, the entire contents of which are incorporated herein by reference.

### TECHNICAL FIELD

The present disclosure relates to a connector with a round shape.

### RELATED ARTS

A type of a round connector is disclosed in JP 2013-246884 A. The round connector has a male connector housing and a bayonet ring mounted on the male connector housing. The bayonet ring is rotatable between a fitting start position and a fitting completion position of the connector. When the male connector housing and a female connector housing of the round connector are fitted, the male connector housing is set to the fitting start position with respect to the female connector housing. Next, the bayonet ring is rotated from the fitting start position to the fitting completion position. At this time, the lock arm of the bayonet ring is deflected, and a lock claw of the lock arm is moved over a position restriction wall of the male connector housing to the fitting completion position. At the fitting completion position, the fitted state of both connector housings is maintained.

### SUMMARY

However, in the conventional connector, since the lock claw is exposed, the locked state of the connector may be released due to external factors. Therefore, there is a concern that halfway fitting between the connector housings may occur.

The present disclosure provide a connector that enables to detect an halfway fitting of a first housing and a second housing and surely maintains the fitted state of the housings.

A connector according to one or more embodiments includes: a first housing with a lockable part on an outer peripheral surface of the first housing and having a housing accommodation portion inside the first housing; a second housing having a housing insertion part, the housing insertion part being configured to be fitted to the housing accommodation portion of the first housing; a rotation member rotatably supported on the first housing and configured to rotate between a fitting start position to a fitting completion position when the first housing and the second housing are fitted; a lock arm including a lock part configured to lock with the lockable part of the first housing in the fitting completion position, an operation section configured to release the lock arm form a locked state, and a fulcrum part connected to an outer peripheral surface of the rotation member at a position between the lock part and the operation section, and configured to swing around the fulcrum part and configured to lock the lock arm or release the lock arm from the locked state by elastic deformation of the fulcrum part; and a fitting detection member configured to detect a fitted state of the first housing and the second housing while being assembled to the rotation member and when moving in a locking direction from a temporally lock position to a fitting confirmation position.

According to the connector with the above described configuration, an halfway fitting between the first housing and the second housing are easily and surely detected by the movement of the fitting detection member, and the fitting state of both housings are surely maintained.

### BRIEF DESCRIPTION OF THE DRAWINGS

FIG. 1 is an exploded perspective view of a connector according to one or more embodiments;

FIG. 2 is a cross-sectional perspective view of a female connector according to the connector;

FIG. 3 is a side view of a bayonet ring for the female connector;

FIG. 4 is a front view of the bayonet ring;

FIG. 5 is a side view of a male connector according to the connector;

FIG. 6A is a perspective view of a fitting detection member assembled to the bayonet ring as viewed from the front side;

FIG. 6B is a perspective view of the fitting detection member as viewed from a rear side;

FIG. 7 is a cross-sectional view of the connector in a fitted state;

FIG. 8A is a cross-sectional view of the connector in which the fitting detection member is in a fully locked position;

FIG. 8B is an enlarged cross-sectional view of portion VIII in FIG. 8A;

FIG. 9A is a cross-sectional view of the connector in which the fitting detection member is in the fully locked position;

FIG. 9B is an enlarged cross-sectional view of portion IX in FIG. 9A;

FIG. 10 is a perspective view of the female connector to which the bayonet ring with the fitting detection member is assembled;

FIG. 11. is a cross-sectional perspective view of the female connector and the male connector before being fitted to each other;

FIG. 12. is a cross-sectional perspective view of a state in which the fitting detection member is in a temporary lock position when the female connector and the male connector are fitted to each other; and

FIG. 13. is a cross-sectional perspective view of a state in which the fitting detection member is in the fully locked position when the female connector and the male connector are fitted to each other.

### DETAILED DESCRIPTION

Various embodiments will be described hereinafter with reference to the accompanying drawings.

Hereinafter, a connector according to one or more embodiments will be described in detail with reference to the drawings.

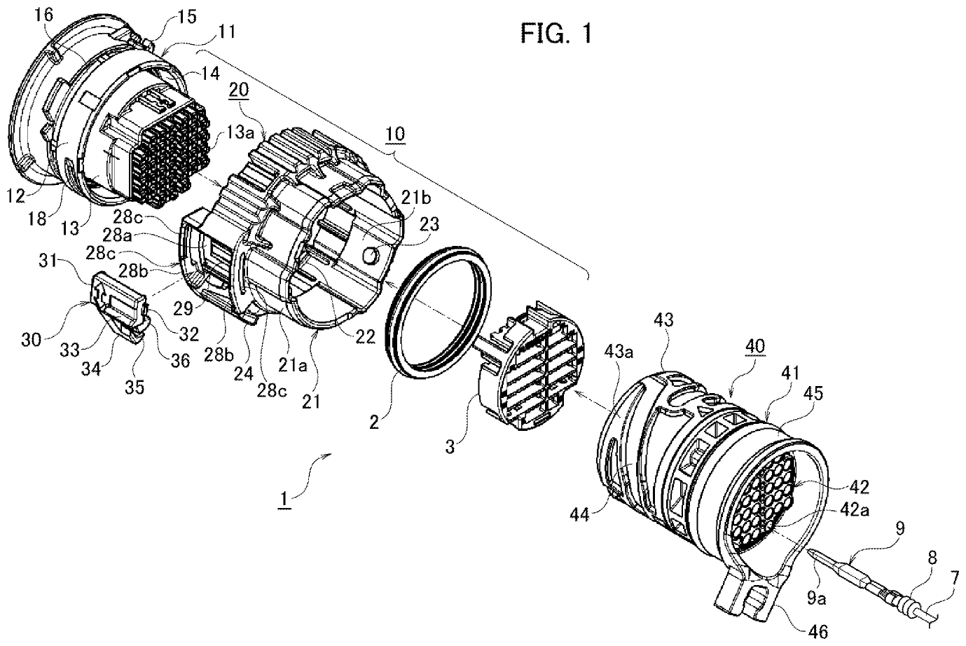

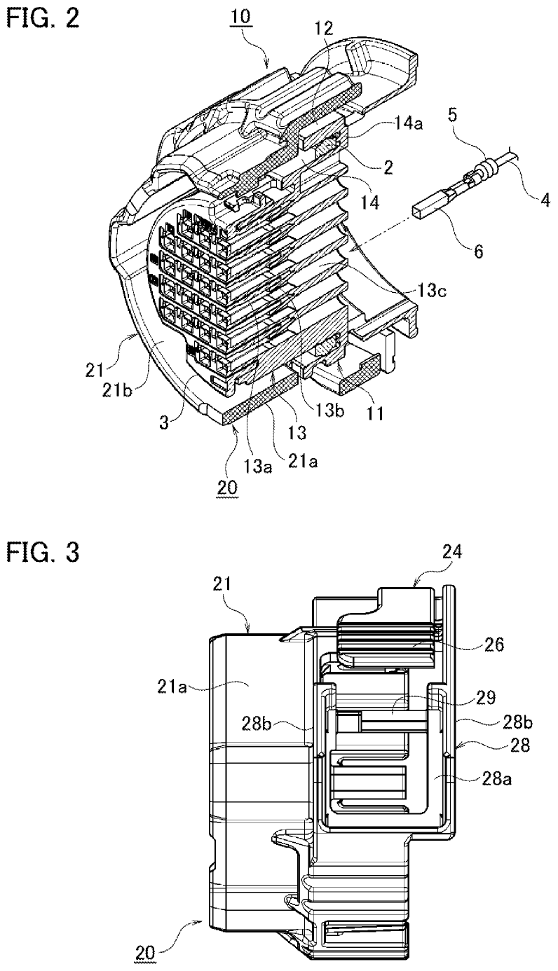

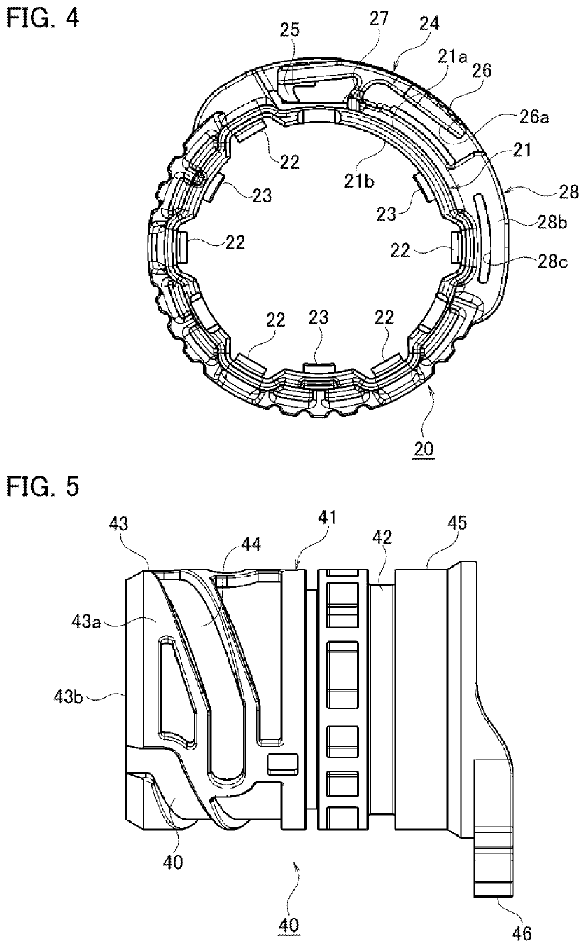

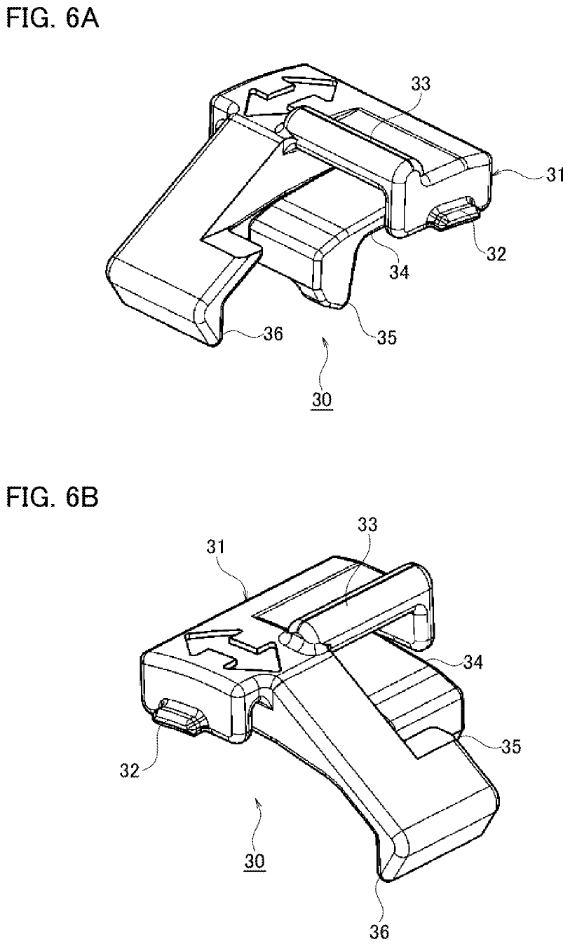

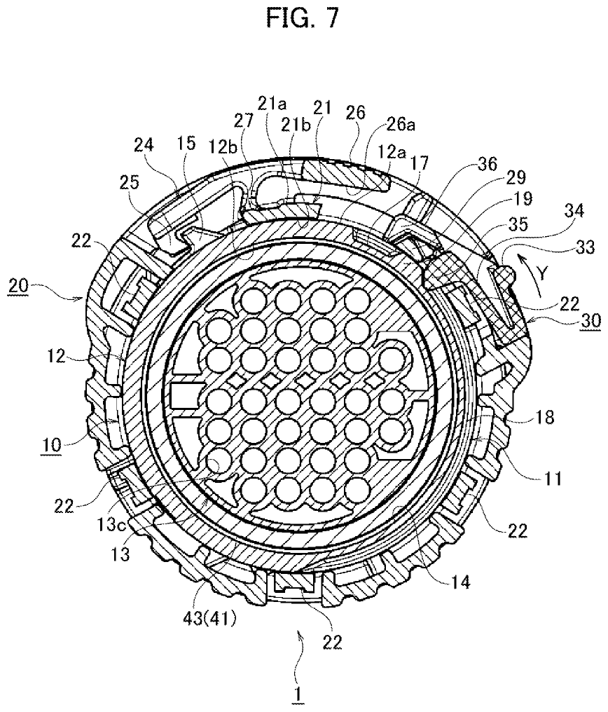

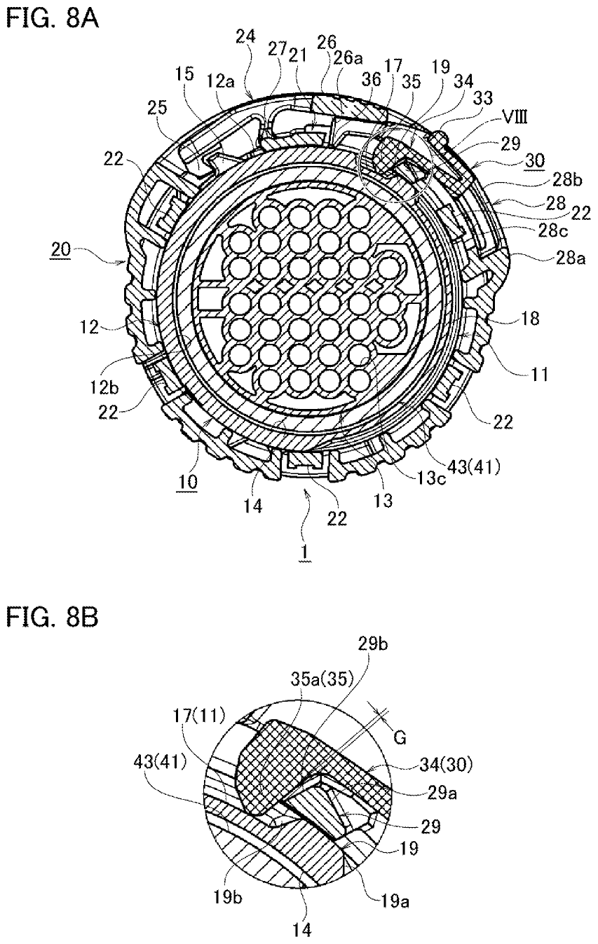

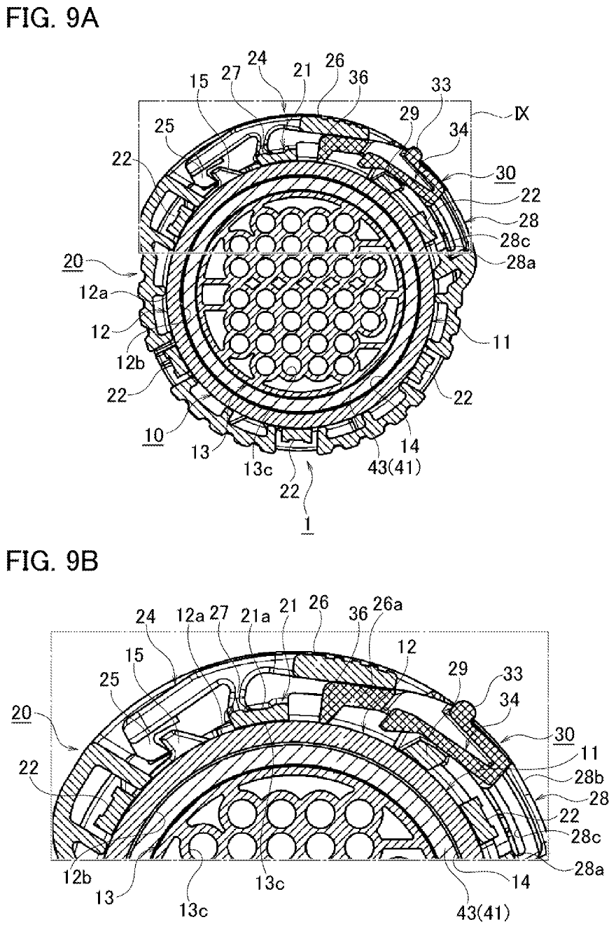

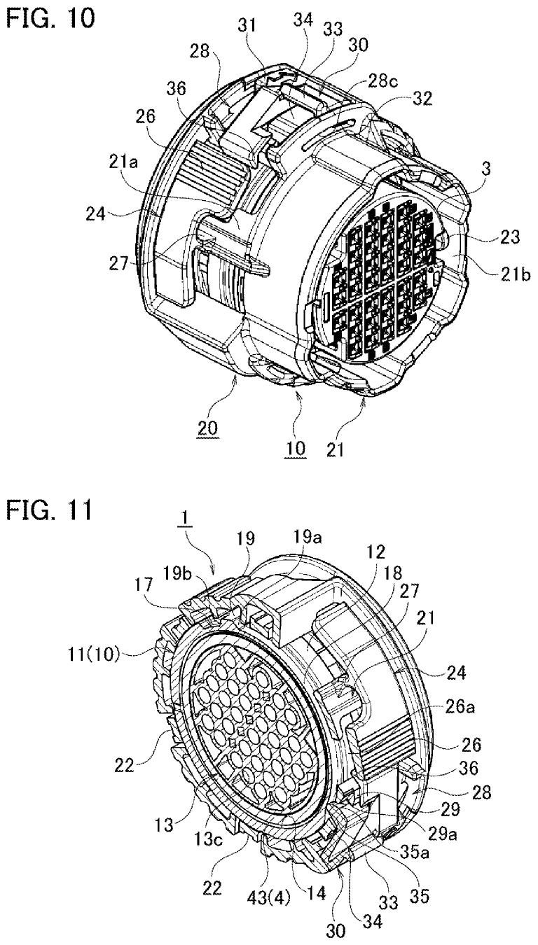

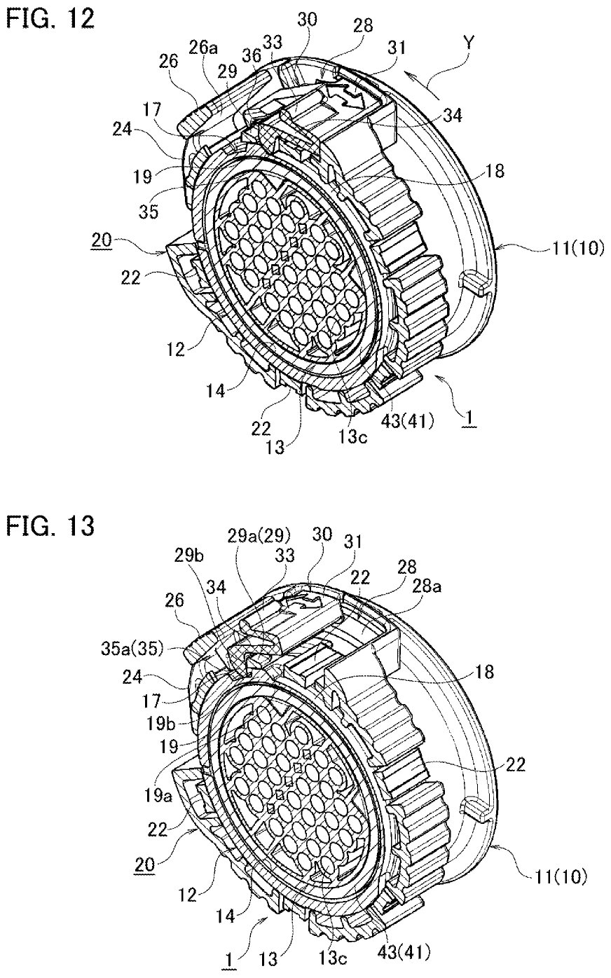

FIG. 1 is an exploded perspective view illustrating an example of a connector according to one or more embodiments. FIG. 2 is a cross-sectional perspective view of a female connector according to the connector. FIG. 3 is a side view of a bayonet ring for the female connector. FIG. 4 is a front view of the bayonet ring. FIG. 5 is a side view of a male connector according to the connector. FIG. 6A is a perspective view of a fitting detection member assembled to the bayonet ring as viewed from the front side. FIG. 6B is a perspective view of the fitting detection member as viewed from a rear side. FIG. 7 is a cross-sectional view of the connector in a fitted state. FIG. 8A is a cross-sectional view of the connector in which the fitting detection member is in a fully locked position. FIG. 8B is an enlarged cross-sectional view of portion VIII of FIG. 8A. FIG. 9A is a cross-sectional view of the connector in which the fitting detection member is in the fully locked position. FIG. 9B is an enlarged cross-sectional view of portion IX in FIG. 9A. FIG. 10 is a perspective view of the female connector to which the bayonet ring with the fitting detection member is assembled. FIG. 11 is a cross-sectional perspective view of the female connector and the male connector before being fitted to each other. FIG. 12 is a cross-sectional perspective view of a state in which the fitting detection member is in a temporary lock position when the female connector and the male connector are fitted to each other. FIG. 13 is a cross-sectional perspective view of a state in which the fitting detection member is in the fully locked position when the female connector and the male connector are fitted to each other.

As illustrated in FIG. 1, a connector 1 with a round shape includes a female connector 10 having a female housing (first housing) 11 that is made of synthetic resin, and a male connector 40 having a male housing (second housing) 41 that is made of synthetic resin. The male housing 41 is configured to be inserted into and fitted to the female housing 11.

As illustrated in FIGS. 1 and 2, the female connector 10 includes the female housing 11, a bayonet ring (rotation member) 20, a packing 2, and a front holder 3. The female housing 11 has a housing accommodation portion 14 inside thereof. The bayonet ring 20 is rotatably supported by the female housing 11.

As illustrated in FIGS. 1 and 2, the female housing 11 has a peripheral wall 12 with cylindrical shape. Inside the peripheral wall 12, the female housing 11 has a terminal accommodation portion 13 having a square columnar shape from a center to a front side (a side where the male terminals 9 are inserted) and a cylindrical shape from the center to the rear side. Between the peripheral wall 12 and the terminal accommodation portion 13, a housing accommodation portion 14 having an annular recessed shape is formed. The housing accommodation portion 14 is configured to insert into and be fitted to a hood portion 43 with a cylindrical shape of the male housing 41.

As illustrated in FIG. 2, a plurality of terminal accommodation chambers 13a configured to accommodate the female terminal (terminal) 6 are formed in the terminal accommodation portion 13. The female terminal 6 is crimped to an electric wire 4 with a rubber plug 5. A flexible lance 13b is formed in the terminal accommodation chamber 13a. The female terminal 6 is accommodated in each terminal accommodation chamber 13a, and is locked to the terminal accommodation portion 13 by the flexible lance 13b. The female terminal 6 is doubly locked to the terminal accommodation portion 13 by a front holder 3 fitted in the front side of the terminal accommodation portion 13. An annular packing (sealing material) 2 made of rubber is accommodated in the closing portion 14a of the housing accommodation portion 14. Between the female housing 11 and the male housing 41 is sealed while the packing 2 accommodated in the housing accommodation portion 14 abuts on a tip part 43a of the hood portion 43 of the male housing 41 that are inserted to the housing accommodation portion 14.

As illustrated in FIGS. 1 and 7, the peripheral wall 12 of the female housing 11 has a lock maintaining protrusion (lockable part) 15 on an outer peripheral surface 12a. As illustrated in FIG. 1, the peripheral wall 12 of the female housing 11 has an annular recessed groove 16 on the outer peripheral surface 12a. Further, as illustrated in FIGS. 7 and 8A, the peripheral wall 12 of the female housing 11 has, on the outer peripheral surface 12a, a main-locking engagement recess 17, a temporally-locking engagement recess 18, and a CPA temporary-locking release projection (temporally-locking release part) 19 located between the main-locking engagement recess 17 and the temporally-locking engagement recess 18. The main-locking engagement recess 17 is formed at a position where release of a locked state between a lock arm 24, which will be described later, and the female housing 11 is restricted. The main-locking engagement recess 17 is configured to engage with a CPA temporally-lock release protrusion 35 of an arm part 34 of a fitting detection member 30 described later. In a state where the CPA temporally-lock release protrusion 35 is engaged with the main-locking engagement recess 17, the CPA temporally-lock release protrusion 35 is maintained at a fully locked position. The temporally-locking engagement recess 18 is formed at a position not restricting the release of the locked state between the lock arm 24 and the female housing 11. The temporally-locking engagement recess 18 is configured to engage with the CPA temporally-lock release protrusion 35 of the arm part 34 of the fitting detection member 30. In a state where the CPA temporally-lock release protrusion 35 is engaged with the temporally-locking engagement recess 18, the CPA temporally-lock release protrusion 35 is maintained at a temporally lock position. Further, the CPA temporary-locking release projection 19 is located between the main-locking engagement recess 17 and the temporally-locking engagement recess 18. When the fitting detection member 30 moves from the temporally lock position to the fully locked position which is a fitting confirmation position, the CPA temporally-lock release protrusion 35 of the arm part 34 of the fitting detection member 30 comes over the CPA temporary-locking release projection 19. The CPA temporary-locking release projection 19 is locked to a CPA main locking projection 29 of a CPA accommodation part 28. As illustrated in FIGS. 1 and 7, the main-locking engagement recess 17 and the temporally-locking engagement recess 18 are arranged in a circumferential direction of the peripheral wall 12 of the female housing 11 with the CPA temporary-locking release projection 19 interposed therebetween. The temporally-locking engagement recess 18 is formed in a range of, for example, 120° in the circumferential direction of the peripheral wall 12 of the female housing 11. That is, the female housing 11 and the male housing 41 are fitted to each other by rotating the bayonet ring 20 in a range of 120° with respect to the female housing 11. The temporally-locking engagement recess 18 is formed in a range corresponding to the movement of the fitting detection member 30 at the temporally lock position.

As illustrated in FIGS. 1 and 4, the bayonet ring 20 has a peripheral wall 21 with a substantially cylindrical shape. The peripheral wall 21 of the bayonet ring 20 has a plurality of rotation support protrusion 22, which are formed by cutting out the inner surface at intervals in the circumferential direction, on an inner periphery at the center in axial direction of the substantially cylindrical shaped bayonet ring 20. The plurality of rotation support protrusions 22 rotatably support the bayonet ring 20 on the female housing 11. Each rotation support protrusion 22 enters the annular recessed groove 16 of the female housing 11. The bayonet ring 20 is rotatably supported by the female housing 11 by the rotation support protrusion 22 slidably arranged in the annular recessed groove 16. The bayonet ring 20 is configured to rotate between a fitting start position and a fitting completion position of the fitting of the female housing 11 and the male housing 41.

As illustrated in FIGS. 1 and 4, the peripheral wall 21 of the bayonet ring 20 has a plurality of cam protrusions 23 on the inner peripheral surface 21b. In one or more embodiments, the cam protrusions 23 are formed at three positions. The cam protrusion 23 is configured to move along a cam groove 44 of the male housing 41 described later, when the female housing 11 and the male housing 41 are fitted to each other. Thereby, the hood portion 43 of the male housing 41 is drawn into the housing accommodation portion 14 of the female housing 11, and the female housing 11 and the male housing 41 are fitted.

As illustrated in FIGS. 4 and 7, the peripheral wall 21 of the bayonet ring 20 has the lock arm 24 on an outer peripheral surface 21a on the base side (rear side). The lock arm 24 has flexibility and is formed in a so-called seesaw lock type shape. The lock arm 24 has a lock projection (lock part) 25, an operation section 26, and a fulcrum part 27 positioned in the middle thereof. The lock projection (lock part) 25 is configured to be lockable to the lock maintaining protrusion 15 of the female housing 11 at the fitting completion position of the female housing 11 and the male housing 41. The operation section 26 is configured to release the locking of the lock projection 25 to the lock maintaining protrusion 15. The fulcrum part 27 is located on a lower side (on an outer peripheral surface 21a side) between the lock projection 25 and the operation section 26 serving as a lock releasing portion, and is connected to the outer peripheral surface 21a of the peripheral wall 21. That is, the lock projection 25, the fulcrum part 27, and the operation section 26 are arranged along the circumferential direction of the peripheral wall 21 of the bayonet ring 20. The lock maintaining protrusion 15 and the lock projection 25 are locked and released by elastically deforming (operating) the lock arm 24 so as to swing around the fulcrum part 27.

As illustrated in FIGS. 8A and 9A, the operation section 26 of the lock arm 24 has an inclined surface 26a on a lower side (a side facing the outer peripheral surface 12a). The inclined surface 26a is inclined so as to approach the outer peripheral surface of the female housing 11 as the inclined surface 26a approaches the fulcrum part 27. The lock arm 24 is configured such that an unlock restriction part 36 of the fitting detection member 30 is able to enter between the operation section 26 and the outer peripheral surface 12a of the female housing 11. In a state of being entered between the operation section 26 and the outer peripheral surface 12a of the female housing 11, the unlock restriction part 36 is pressed to the outer peripheral surface 12a side of the female housing 11 by the inclined surface 26a of the operation section 26. By the pressing action, as illustrated in FIG. 8 B, the CPA temporally-lock release protrusion 35 of the fitting detection member 30 is pushed back to a side of the CPA main locking projection 29 of the CPA accommodation part 28 described later.

Further, as illustrated in FIGS. 3 and 4, the peripheral wall 21 of the bayonet ring 20 has the CPA accommodation part (a fitting-detection-member accommodation part) 28 configured to movably accommodate the fitting detection member 30 therein. The CPA accommodation part 28 is provided at a position adjacent to the lock arm 24 on the outer peripheral surface 21a. The CPA accommodation part 28 serves as a slidable space for the fitting detection member 30. The CPA accommodation part 28 has a bottom wall portion 28a, side wall portions 28b extending vertically from both ends of the bottom wall portion 28a, and a guide groove hole 28c formed at the center of the side wall portions 28b. A guide projection 32 of the fitting detection member 30 is configured to slidably fit into the guide groove hole 28b. Therefore, the fitting detection member 30 is movable in the circumferential direction of the CPA accommodation part 28. The CPA main locking projection (main locking part) 29 configured to lock the fitting detection member 30 at the fitting confirmation position is provided at a center of the bottom wall portion 28a. The fitting confirmation position of the fitting detection member 30 is the fitting completion position of the fitting between the female housing 11 and the male housing 41.

As illustrated in FIGS. 8A and 9A, the fitting detection member (CPA member: Connector Position Assurance member) 30 is assembled to the CPA accommodation part 28. The fitting detection member 30 detects a fitted state of the female housing 11 and the male housing 41. That is, the fitting detection member 30 in a state of being assembled to the CPA accommodation part 28 of the bayonet ring 20 is configured to detect the fitted state between the female housing 11 and the male housing 41. At this time, the fitting detection member 30 is operated to slide from the temporally lock position illustrated in FIG. 12 to the locking direction Y toward the fitting confirmation position illustrated in FIG. 13.

As illustrated in FIGS. 6A and 6B, the fitting detection member 30 is made of synthetic resin and has a CPA body 31 with a block shape. On both side surfaces of the CPA main body 31, the guide protrusions 32 configured to be slidable in respective guide groove holes 28c formed in both side wall portions 28b of the CPA accommodation part 28 are protrudingly provided. On an upper surface of the CPA main body 31, an operation part 33 configured to slide the CPA main body 31 is protrudingly provided. A lower surface of the CPA body 31 is integrally provided with the arm part 34 with flexibility. The arm part 34 with flexibility has the CPA temporally-lock release protrusion (temporally-lock release protrusion) 35 configured to lock to the CPA main locking projection 29 of the CPA accommodation part 28. The unlock restriction part 36 with flexibility is integrally formed on the lower surface of the CPA main body 31 as a part of the structure. The unlock restriction part 36 is configured to enter between the operation section 26 of the lock arm 24 and the outer peripheral surface 12a of the female housing 11, and restricts the unlock between the lock projection 25 and the lock maintaining protrusion 15.

As illustrated in FIGS. 1 and 5, the male housing 41 of the male connector 40 includes a terminal holding portion 42 with cylindrical shape and the hood portion (housing insertion part) 43 having the cylindrical shape. The hood portion 43 extends integrally forward in an axial direction of the terminal holding portion 42 with cylindrical shape. The hood portion 43 is configured to fit to the housing accommodation portion 14 of the female housing 11. The terminal holding portion 42 with cylindrical shape has a plurality of electric wire accommodation chambers 42a. The plurality of electric wires 7 with rubber plugs 8 having male terminals (terminals) 9 crimped thereto are accommodated in the plurality of electric wire accommodation chambers 42a. A tab part 9a of the male terminal 9 crimped to the electric wire 7 accommodated in each electric wire accommodation chamber 42a projects into the hood portion 43.

The hood portion 43 of the male housing 41 has a plurality of the cam grooves 44 on an outer peripheral surface 43a. In the one or more embodiments, the cam grooves 44 are formed at three positions. The cam groove 44 is configured to be engaged with the cam protrusion 23 of the bayonet ring 20. Each cam groove 44 is formed in a spiral shape. The bayonet ring 20 is rotated to move each cam protrusion 23 along each cam groove 44, so that the hood portion 43 with cylindrical shape of the male housing 41 is drawn into the housing accommodation portion 14 having an annular recessed shape of a female housing 11. By this action, the female housing 11 and the male housing 41 are fitted to each other. A short hood portion 45 is also integrally provided on the rear side of the terminal holding portion 42 with cylindrical shape. On the lower side thereof, a substantially C-shaped protrusion 46 is protruded. The protrusion 46 is a part configured to mount and fix the male connector 40 onto the vehicle body so as not to rotate.

An action of the connector 1 according to the one or more embodiments, as illustrated in FIGS. 10 and 11, from assembling of the bayonet ring 20 to which the fitting detection member 30 is attached to the female housing 11 of the female connector 10, and the fitting of the female connector 10 and the male connector 40 will be described.

The bayonet ring 20 rotatably supported by the female housing 11 is rotated from the fitting start position to the fitting completion position of the female housing 11 and the male housing 41. At this time, the cam protrusion 23 of the bayonet ring 20 enters in and moves along the cam groove 44 of the male housing 41. By this movement, the hood portion 43 with cylindrical shape of the male housing 41 is drawn into the housing accommodation portion 14 with the annular recessed shape of the female housing 11. As a result, the female housing 11 and the male housing 41 are fitted.

As illustrated in FIG. 7, when the female housing 11 and the male housing 41 are fitted, the lock projection 25 of the lock arm 24 of the bayonet ring 20 is locked to the lock maintaining protrusion 15 of the female housing 11. Thereby, the female housing 11 and the male housing 41 are locked in the fitted state. At this time, as illustrated in FIGS. 7 and 12, the CPA temporally-lock release protrusion 35 of the flexible arm part 34 of the fitting detection member 30 is locked (temporarily locked) to the CPA temporary-locking release projection 19 of the female housing 11. As a result, the movement of the fitting detection member 30 in the locking direction Y is restricted.

When the operation section 33 is operated to move the fitting detection member 30 from the temporally lock position in the locking direction Y, as illustrated in FIG. 13, the CPA temporally-lock release protrusion 35 gets over the CPA temporary-locking release projection 19 and is locked to the CPA main locking projection 29 of the CPA accommodation part 28. At this time, as illustrated in FIG. 8A, the unlock restriction part 36 of the fitting detection member 30 enters between the operation section 26 of the lock arm 24 and the outer peripheral surface 12a of the female housing 11. During the entering, the unlock restriction part 36 is pressed to the outer peripheral surface 12a side of the female housing 11 by the inclined surface 26a of the operating section 26. By this pressing, as illustrated in FIG. 8B, the CPA temporally-lock release protrusion 35 is pushed back to the CPA main locking projection 29 side of the CPA accommodation part 28. As a result, the clearance G between the female housing 11, the bayonet ring 20, and the fitting detection member 30 is eliminated, and occurrence of rattling is suppressed. This action leads to the prevention of abnormal noise on the vehicle.

Next, the transition from a temporally locked state to a full locked state of the fitting detection member 30 will be described in detail. As illustrated in FIGS. 12 and 13, in the temporary locked state, the CPA temporally-lock release protrusion 35 is in the temporally-locking engagement recess 18. When the fitting detection member 30 moves in the locking direction Y, the CPA temporally-lock release protrusion 35 gets over the CPA temporary-locking release projection 19. At this time, the tip protrusion 35a of the CPA temporally-lock release protrusion 35 slides between an inclined surface 19a on the front side of the CPA temporary-locking release projection 19 and the inclined surface 29a on the front side of the CPA main locking projection 29 of the CPA accommodation part 28. That is, while the CPA temporally-lock release protrusion 35 moves through the temporally-locking engagement recess 18, the CPA main locking projection 29 is restricted from getting over the CPA temporary-locking release projection 19. When the CPA temporary-locking release projection 19 and the CPA main locking projection 29 are positioned to overlap in the radial direction, the CPA temporally-lock release protrusion 35 is enabled to move over the CPA main locking projection 29 by using the inclination of the inclined surface 19a of the CPA temporary-locking release projection 19.

When the CPA temporally-lock release protrusion 35 completely gets over the CPA temporary-locking release projection 19, the CPA temporally-lock release protrusion 35 enters the main-locking engagement recess 17. As a result, the CPA temporally-lock release protrusion 35 is locked to the locking surface 29b on the rear side of the CPA main locking projection 29 of the CPA accommodation part 28, and the CPA is in the fully locked state.

Further, when the fitting detection member 30 is fully locked, the unlock restriction part 36 is sandwiched between the operation section 26 of the lock arm 24 and the female housing 11. Therefore, even if an external force is applied to the operation section 26 of the lock arm 24, the fully locked and fitted state of the female housing 11 and the male housing 41 is not released. As a result, the fully locked state of the fitting detection member 30 serves as the fitting confirmation position of the fitting detection member 30, and the normal fitted state of the female housing 11 and the male housing 41 is detected and ensured. Retention of the fitted and locked state of the female housing 11 and the male housing 41 is ensured.

As described above, the female housing 11 and the male housing 41 are fitted and locked, and then the fitting detection member 30 is moved from the temporally lock position to the fully locked position, so that the fitted and locked state of the female housing 11 and the male housing 41 is easily and surely detected. Further, the fitted and locked state of the female housing 11 and the male housing 41 is reliably maintained by the fitting detection member 30.

Although the one or more embodiments have been described above, the embodiments are not limited thereto, and various modifications are possible within the scope of the gist of the embodiment.

That is, in the above embodiment, the cam groove is provided in the hood portion of the male housing, and the cam protrusion is provided on the bayonet ring. However, a cam protrusion may be provided on the hood portion of the male housing, and a cam groove may be provided on the bayonet ring. While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A connector comprising:
a first housing with a lockable part on an outer peripheral surface of the first housing and having a housing accommodation portion inside the first housing;
a second housing having a housing insertion part, the housing insertion part being configured to be fitted to the housing accommodation portion of the first housing;
a rotation member rotatably supported on the first housing and configured to rotate between a fitting start position to a fitting completion position when the first housing and the second housing are fitted;
a lock arm including a lock part configured to lock with the lockable part of the first housing in the fitting completion position, an operation section configured to release the lock arm form a locked state, and a fulcrum part connected to an outer peripheral surface of the rotation member at a position between the lock part and the operation section, and configured to swing around the fulcrum part and configured to lock the lock arm or release the lock arm from the locked state by elastic deformation of the fulcrum part; and
a fitting detection member configured to detect a fitted state of the first housing and the second housing while being assembled to the rotation member and when moving in a locking direction from a temporally lock position to a fitting confirmation position.

2. The connector according to claim 1, wherein
the rotation member includes a fitting-detection-member accommodation part configured to movably accommodate the fitting detection member in the fitting-detection-member accommodation part,
the fitting-detection-member accommodation part includes a main locking part configured to lock the fitting detection member at the fitting confirmation position, and
the fitting detection member is provided with; an arm part with flexibility and including a temporally-lock release protrusion to be locked to the main locking part, a lock-release restriction section configured to restrict unlocking of the locked state between the lock part of the lock arm and the lockable part of the first housing by entering between the operation section of the lock arm and the outer peripheral surface of the first housing, and an operation part configured to perform an operation to move the fitting detection member.

3. The connector according to claim 2, wherein
the outer peripheral surface of the first housing is provided with; a main-locking engagement recess configured to maintain a position of the temporally-lock release protrusion of the arm part at a position being engaged with the main-locking engagement recess where a release from the locked state between the lock arm and the first housing are restricted, and a temporally-locking engagement recess configured to engage with the temporally-lock release protrusion of the arm part at a position where the release from the locked state between the lock arm and the first housing are not restricted and maintain a position of the temporally-lock release protrusion, and a temporally-locking release part positioned between the main-locking engagement recess and the temporally-locking engagement recess, and
when the fitting detection member moves from the temporally lock position to the fitting confirmation position, which is the fully locked position, the temporally-lock release protrusion gets over the temporally-locking release part and locks to the main locking part.

4. The connector according to claim 2, wherein
the operation section of the lock arm includes an inclined surface inclined to approach the outer peripheral surface of the first housing as the inclined surface approaches the fulcrum part, and
the inclined surface of the operation section is configured to press the lock-release restriction section toward an outer-peripheral-surface side of the first housing, when the lock-release restriction section of the fitting detection member enters between the operation section of the lock arm and the outer peripheral surface of the first housing, and the temporally-lock release protrusion of the fitting detection member is pushed back to a main-locking-part side of the fitting-detection-member accommodation part.

5. The connector according to claim 1, wherein
the first housing further has an annular recessed groove in the outer peripheral surface of the first housing,
the rotation member further includes a rotation support protrusion configured to enter into the annular recessed groove and rotatably support the rotation member onto the first housing and a plurality of cam protrusions formed on an inner peripheral surface of the rotation member,
the second housing further has a plurality of cam grooves formed in an outer peripheral surface of the second housing and configured to engage with the plurality of cam protrusions, and
when the rotation member rotates, the housing insertion part of the second housing is drawn into the housing accommodation portion of the first housing while each of the plurality of cam protrusions that move along corresponding cam groove of the plurality of cam grooves and the first housing and the second housing are fitted to each other.
